(19) United States
(12) Patent Application Publication
(10) Pub. No.: US 2007/0156815 A1
(43) Pub. Date: Jul. 5, 2007

(54) Method, system and entities for multicast content pushing

(75) Inventors: Sujeet Mate, Tampere (FI); Umesh Chandra, Mountain View, CA (US); Kai Willner, Tempere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/606,194

(22) Filed: Nov. 30, 2006

Related U.S. Application Data
(60) Provisional application No. 60/754,640, filed on Dec. 30, 2005.

(51) Int. Cl. G06F 15/16

(52) U.S. Cl. 709/204; 709/231

(57) ABSTRACT

The present invention discloses a method for multicast content pushing between a server entity (UA-I) and at least one client entity (UA-II) as well as a corresponding system and client and server entities. The method comprises the steps of inviting, by the server entity, at least one client entity to join a multicast content streaming session, answering, by the at least one client entity to the server entity, whether the client entity joins the invited multicast content streaming session, releasing, at the server entity and to the server entity, a request for multicast content streaming, responding, by the server entity, to the released request by sending a response to the request to the at least one client entity that joined the multicast content streaming session.

### FIELD OF THE INVENTION

The present invention relates to a method and system for multicast content pushing between a server entity and at least one client entity as well as to the corresponding server entity and client entity for multicast content pushing.

### BACKGROUND

With the increasing popularity and acceptance of modern communication, a vast variety of applications was and is developed to provide additional services to the end users of communication devices.

Thus, using means of communication does not only allow for making a conventional phone call, but in the meantime also enables users to access the Internet from their wirebound as well as from their mobile terminal, or—with some adaptations and an appropriate application being run on it—to use your mobile terminal for navigation purposes.

Another example for a quite popular application is gaming or sending of images that were taken with a digital camera integrated to the communication device. Even beyond the mere sending of e.g. image data, is the sharing of such data with plural other users, which may access the image data at a time they wish to do so.

Such a sharing of content such as images with communication partners is becoming particularly popular. To this end, an image is not only sent to one specific communication partner, but it is made available, for example at a server, to be accessed by a plurality of other users of communication devices.

For the purpose of the present invention to be described herein below, it should be noted that

a communication device may for example be any device by means of which a user may access a communication network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals are particularly suitable for being used in connection with the present invention;

a communication device can act as a client entity or as a server entity in terms of the present invention, or may even have both functionalities integrated therein;

although reference was made herein before to images, this exemplifies only a specific example of content; content as used in the present invention is intended to mean data of at least one of audio, video, image, text, and metadata descriptive of attributes of the audio, video, image and/or text data, any combination thereof or even, alternatively or additionally, other data such as, as a further example, program code of an application program to be accessed/downloaded (also referred to as executable code data);

method steps likely to be implemented as software code portions and being run using a processor at one of the server/client entities, are software code independent and can be specified using any known or future developed programming language as long as the functionality defined by the method steps is preserved;

generally, any method step is suitable to be implemented as software or by hardware without changing the idea of the present invention in terms of the functionality implemented;

method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc., using for example ASIC components or DSP components, as an example;

devices can be implemented as individual devices, but this does not exclude that they are implemented in a distributed fashion throughout the system, as long as the functionality of the device is preserved.

In the patent application filed in the name of Nokia Corporation on Dec. 23, 2003 under the Ser. No. PCT/IB 03/06134, a method, system and terminals for exchanging images and image related data between at least two end points are described.

Insofar, the above document describes a method for exchanging images as a type of content between a server entity and a client entity as respective end points. That prior art method comprises the steps of establishing a session between the server entity and the client entity based on a session control layer protocol, and initiating a content exchange session between the server entity and the client entity based on an application layer transport protocol.

The session control layer protocol is the Session Initiation Protocol, SIP, and the session established is a SIP session operated on a SIP/SDP protocol stack and is thus located on layers 5 to 7 of the OSI reference model (SDP=Session Description Protocol, OSI=Open System Interconnection). The application layer (OSI layer 7) session protocol, in turn, is the JPEG 2000 Interactive Protocol, JPIP, and the content exchange session established is a JPIP session. Reference is made to the SIP session layer as the control layer for the exchange of content, whereas the JPIP session layer is referred to as the data layer in which the content (application data) are carried.

Note, however, that SIP and JPIP are used only as an example as they have proved to be particularly suited for (interactive and real-time) content exchange so far. However, making reference to these particular standards does not limit the principles of the present invention as described later to be applied to other protocols, whether existing ones or future developed ones.

JPEG 2000 is the state-of-the-art image compression standard being developed under the aegis of ISO/IEC and ITU-T. Part 9 of the standard, JPEG 2000 Interactive Protocol (JPIP), is now an international standard. JPIP defines, in an extensible manner, syntaxes and methods for remote interrogation and optional modification of JPEG 2000 codestreams and files in accordance with their definition in ISO/IEC 15444. JPIP is a protocol that allows for the interactive and progressive transmission of JPEG 2000 coded data in a client-server scenario over a network. The JPIP protocol consists of a structured series of interactions between a client and a server by means of which image file metadata, structure and partial or whole image codestreams may be exchanged in a communication efficient manner. This is a protocol that allows for the interactive and progressive transmission of JPEG 2000 coded data in a client-server scenario over a network.

The JPIP standard also defines, in an extensible manner, the semantics and the values to be exchanged, and suggests how these parameters could be signaled over different network transports. The JPIP protocol can enable an interactive image browsing, image and metadata retrieval, and image uploading system.

Metadata are data descriptive of attributes of the content such as e.g. audio, video, image and/or text data, or the like as mentioned before. This implies a size information, date information of the content (e.g. creation date, modification date), or any other attributes for files containing content data.

The Session Initiation Protocol (SIP) (specified e.g. in RFC 2543, RFC 3261), is an application-layer signaling (control) protocol defined by IETF. It is used for creating, modifying and terminating sessions with one or more participants. These sessions could be IP based videoconferences, VoIP (Voice over IP), multimedia distribution, messaging sessions, etc. SIP/SDP provides for parameter negotiation before initiating the session. Actually it is SDP, which provides the negotiation of the parameters. The SIP (INVITE, 200 OK, etc) message body carries the SDP parameters. 3GPP standard has also decided to go with SIP.

SIP also has a feature to provide for transmission of mid-session control data using the SIP INFO method (specified in RFC 2976). The purpose of SIP INFO messages is to carry application level information along the SIP signaling path (or they can be sent end-to-end). The SIP INFO method is not used to change the state of SIP calls/SIP sessions, or the parameters of the sessions SIP/SDP initiates. Rather, it merely sends optional application layer information, generally related to the session.

SIP/SDP is thus used to initiate a session between two JPIP-enabled terminals. This allows for parameter negotiation before the session is established. SIP defines session control messages used during the setup and teardown stages of SIP controlled sessions. In addition, SIP re-INVITE is employed in case of a change in characteristics of the session. But this is used generally in case of a change in properties of a media flow or content flow. Like for example in case the JPIP session needs to be started on another port.

From Internet applications, it is known to use “File Delivery over Unidirectional Transport” known as FLUTE. This is a protocol for the unidirectional delivery of files, i.e. content over the Internet, which is particularly suited to multicast networks.

Furthermore, a method and system, for exchanging content between a server entity and a client entity as well as the corresponding server and client entities for exchanging content are described in the provisional application for patent of the present applicant which was filed on May 4, 2005 with the USPTO under the Ser. No. 60/677,322 (followed by a regular patent application filed with the USPTO on Jun. 30, 2005 under the Ser. No. 11/170,136).

Sharing content such as still images/graphics using MMS/Email were one of the first services offering visual content transfer. The existing image sharing services have, however, one or more of the following drawbacks:

They are not scalable:

An image to be shared with N users, would require N separate messages to be sent.

They are not bandwidth efficient:

Two messages having overlap in their image content need to send the same data twice.

They are not easily integrated with other services:

Most of the existing image-sharing services are not flexible enough to be integrated with other services like multiparty video conferencing, etc.

They are not possible to stream a string of images as part of a logical session:

Most of the present services are more like an event than a session.

Since JPIP based image streaming is a new concept, as such this involves new problems as above, for which no previous solution exists.

### SUMMARY

In consideration of the above, it is an object of the present invention to provide a method and system for multicast content pushing between a server entity and at least one client entity, as well as a correspondingly configured server entity which are free from the above inconveniences.

According to an exemplary implementation of the present invention, this object is achieved by

a method for multicast content pushing between a server entity and at least one client entity, the method comprising:

inviting, by the server entity, at least one client entity to join a multicast content streaming session;

answering, by the at least one client entity to the server entity, whether the at least one client entity joins the invited multicast content streaming session;

releasing, at the server entity and to the server entity, a request for multicast content streaming; and

responding, by the server entity, to the released request by sending a response to the request to the at least one client entity that joined the multicast content streaming session.

According to advantageous further refinements of the exemplary implementation of the invention as defined under the above aspect

said inviting further comprises sending invitation information to the at least one client entity in a signaling message of an ongoing session;

said inviting further comprises sending invitation information to the at least one client entity within a call of an ongoing session;

said releasing further comprises generating a request for multicast content streaming at the server entity via a user-interface;

said releasing further comprises retrieving a request for multicast content streaming at the server entity from pre-stored requests;

the request is a JPIP request and the multicast streaming content is JPEG 2000 data;

said responding further comprises composing a response including the multicast streaming content and the request including parameters for multicast content streaming;

said responding further comprises sending the response using a separate multicast content streaming transport session, which is operative in tandem to an ongoing session used for invitation to join the multicast content streaming session;

the multicast content streaming transport session is a FLUTE session;

receiving the response at the at least one client entity that joined the multicast content streaming session, the response including the multicast streaming content and the request including parameters for multicast content streaming; decoding the response; and rendering the multicast streaming content at the at least one client entity using the parameters contained in the response.

According to an exemplary implementation of the present invention, this object is achieved by a system, the system being configured for multicast content pushing between a server entity and at least one client entity and comprising invitation unit, at the server entity, configured to invite the at least one client entity to join a multicast content streaming session;

answering unit, at the at least one client entity, configured to answer to the server entity, whether the at least one client entity joins the invited multicast content streaming session;

releasing unit, at the server entity, configured to release to the server entity a request for multicast content streaming; and

responder unit, at the server entity, configured to respond to the released request by sending a response to the request to the at least one client entity that joined the multicast content streaming session.

According to advantageous further refinements of the exemplary implementation of the invention as defined under the above aspect

the invitation unit is configured to send invitation information to the at least one client entity in a signaling message of an ongoing session;

the invitation unit is configured to send invitation information to the at least one client entity within a call of an ongoing session;

the releasing unit comprises a generating unit configured to generate a request for multicast content streaming at the server entity via a user-interface;

the releasing unit comprises a retrieval unit configured to retrieve a request for multicast content streaming at the server entity from a memory containing pre-stored requests;

the request is a JPIP request;

the responder unit is configured to compose a response including multicast streaming content and the request including parameters for multicast content streaming;

the responder unit is configured to send the response using a separate multicast content streaming transport session, which is operative in tandem to a session used for invitation to join the multicast content streaming session;

the multicast content streaming transport session is a FLUTE session.

According to an exemplary implementation of the present invention, this object is achieved by a server entity configured to multicast content pushing to at least one client entity, the server entity comprising:

invitation unit configured to invite at least one client entity to join a multicast content streaming session;

receiving unit configured to receive an answer from the at least one client entity, whether the at least one client entity joins the invited multicast content streaming session;

releasing unit configured to release to the server entity a request for multicast content streaming; and

responder unit configured to respond to the released request by sending a response to the request to the at least one client entity that joined the multicast content streaming session.

According to advantageous further refinements of the exemplary implementation of the invention as defined under the above aspect

the invitation unit is configured to send invitation information to the at least one client entity in a signaling message of an ongoing session;

the invitation unit is configured to send invitation information to the at least one client entity within a call of an ongoing session;

the releasing unit comprises generating unit configured to generate a request for multicast content streaming at the server entity via a user-interface;

the releasing unit comprises retrieval unit configured to retrieve a request for multicast content streaming at the server entity from a memory containing pre-stored requests;

the request is a JPIP request and content being streamed is JPEG 2000 data;

the responder unit is configured to compose a response including multicast streaming content and the request including parameters for multicast content streaming;

the responder unit is configured to send the response using a separate multicast content streaming transport session, which is operative in tandem to a session used for invitation to join the multicast content streaming session;

the multicast content streaming transport session is a FLUTE session.

According to an exemplary implementation of the present invention, this object is achieved by a client entity configured to receive multicast content pushed from a server entity, the client entity comprising:

a receiver configured to receive a response including multicast streaming content and the request including parameters for content streaming;

a decoder configured to decode the response; and

a rendering unit configured to render the multicast streaming content at the at least one client entity using parameters contained in the response.

Also under this aspect, it is advantageous that the request is a JPIP request and the multicast streaming content is JPEG 2000 data.

Additionally, according to an exemplary implementation of the present invention, a computer program product is disclosed, configured for a client-server computer system and comprising processor implementable instructions stored as software code portions on a computer-readable medium loadable into an internal memory of the client-server computer, configured for providing for multicast content pushing between a server entity and at least one client entity, comprising:

inviting, by the server entity, at least one client entity to join a multicast content streaming session;

answering, by the at least one client entity to the server entity, whether the at least one client entity joins the invited multicast content streaming session;

releasing, at the server entity and to the server entity, a request for multicast content streaming; and

responding, by the server entity, to the released request by sending a response to the request to the at least one client entity that joined the multicast content streaming session.

Advantageously, under that aspect,

said releasing further comprises generating a request for multicast content streaming at the server entity via a user-interface;

said releasing further comprises retrieving a request for multicast content streaming at the server entity from pre-stored requests.

In particular,

the computer program product comprises a computer-readable medium on which the software code portions are stored; and/or

the computer program product is directly loadable into an internal memory of the client-server computer system.

Various aspects of the method, system, server entity and client entity have been identified above. It is to be understood that individual features under one of these aspects can be combined with each other.

As has become evident from the above, this invention relates to the use of e.g. JPIP in a novel fashion over, preferably reliable, multicast transport networks enabling JPIP based image streaming. In connection with the present invention, JPIP usage in a novel fashion is disclosed, which was termed as “JPIP-PUSH”. JPIP-PUSH is a one-way streaming of JPIP response together with an underlying locally generated JPIP request. Using the combination of JPIP request and response data, the receiver of such data stream gets the data using minimal bandwidth and can decode it with optimum resource utilization. This one-way media and/or content push is extendible over a reliable multicast network to provide a scalable and robust image streaming. Coupling JPIP-PUSH with a Rich Call scenario, allows for a more interactive multiparty image sharing experience.

Hence, the presented solution of using the so-called JPIP-PUSH method, to the best of the inventors' knowledge, has not been introduced in multimedia streaming environment.

Accordingly, several, but at least the following, advantages can be achieved individually or in combination: This invention enables image streaming in JPIP-PUSH based image sharing session. It tackles the problems of scalability, efficiency and integration with other media services.

In this connection, it has to be pointed out that advantageously

using JPEG 2000 coded images for such a PUSH scenario allows a device with limited capabilities to quickly and efficiently extract the codestream; JPEG 2000 images store data in such a way that provides for progressive transmission, scalable quality, and random access/processing among others; these features enable a low-memory device (typically mobile devices) with low-processing speed and limited power capacity to handle high-resolution mega pixel images;

using JPIP-PUSH allows an otherwise point-to-point protocol to be extended to a truly scalable sharing scenario/multicast scenario;

using FLUTE as transport provides a multicast error resilient framework for sharing image and/or content codestream;

the invention enables “image streaming” service over multicast networks;

the proposed scenario is compatible to existing multicast multimedia streaming services with minimum additional infrastructure requirements;

it allows a more interactive sharing of images (compared to e.g. MMS, though not as interactive as the typical point-to-point scheme);

it allows for a more controlled access to image data; this could be required in cases, where a high-resolution image has information that is suitable to be shared with public only at lower resolutions.

To the best of the inventors' knowledge, there is no known disadvantage of this solution.

### BRIEF DESCRIPTION OF THE DRAWINGS

The invention is described herein below with reference to the accompanying drawings, in which

FIG. 1 shows a conventional usage JPIP Interactive image browsing system;

FIG. 2 shows JPIP-PUSH usage;

FIG. 3 shows a case how JPIP-PUSH would work with FLUTE in a reliable multicast transport scenario;

FIG. 4 shows a typical JPIP-PUSH image streaming system;

FIG. 5 shows an example use case, where the image sharer using the user interface UI on the phone browses the image, and then “pushes” the selected ROI to the JPIP-PUSH clients;

FIG. 6 shows a signaling diagram for the method according to an exemplary implementation of the present invention;

FIG. 7 shows a block circuit diagram of a server entity; and

FIG. 8 shows a block circuit diagram of a client entity.

### DETAILED DESCRIPTION OF EXEMPLARY EMBODIMENTS

The invention is described herein below with reference to exemplary embodiments as illustrated in the accompanying drawings.

The drawings illustrate aspects and/or individual partial concepts that are realized by the present invention when implemented. Concepts and their features can be realized as an individual feature or can be combined with other concepts disclosed herein and their respective features without any restriction. In particular, a terminal device such as a mobile phone of a user may act as a server entity as well as a client entity and is thus equipped with both functionalities and/or corresponding hardware units (or means) although the present specification describes those aspects individually in order to reduce complexity of the description and drawing illustration.

This invention as described below deals with utilizing JPIP (as an example) in a particular way to allow for one-way image media streaming. JPIP is a significant means for enabling. interactive image solutions over resource-constrained terminals and bandwidth limited networks. With increasing importance of multimedia services, the importance of a scalable, reliable, bandwidth efficient and last but not least easily integrated image streaming service could not be over stressed. Also, Rich calls gain more and more attention with an array of multimedia service offerings. Integrating this service with multiparty video-conferencing, would provide for enhanced user experience.

As is evident from the name, the concept of “JPIP-PUSH” as proposed by the present invention is a derivative of the standard JPIP protocol used for interactive sharing of JPEG 2000 coded images. To better understand how the proposed concept of JPIP-PUSH works, a brief overview of how a typical JPIP system works is given herein below.

Note that JPIP is used as an example only and other protocols preserving the functionality and advantages of JPIP may be used instead in connection with the present invention.

Typically a JPIP-based interactive imaging system can be classified into four broad categories:

1) Server-initiated server-controlled

2) Client-initiated server-controlled

3) Server-initiated client-controlled

4) Client-initiated client-controlled

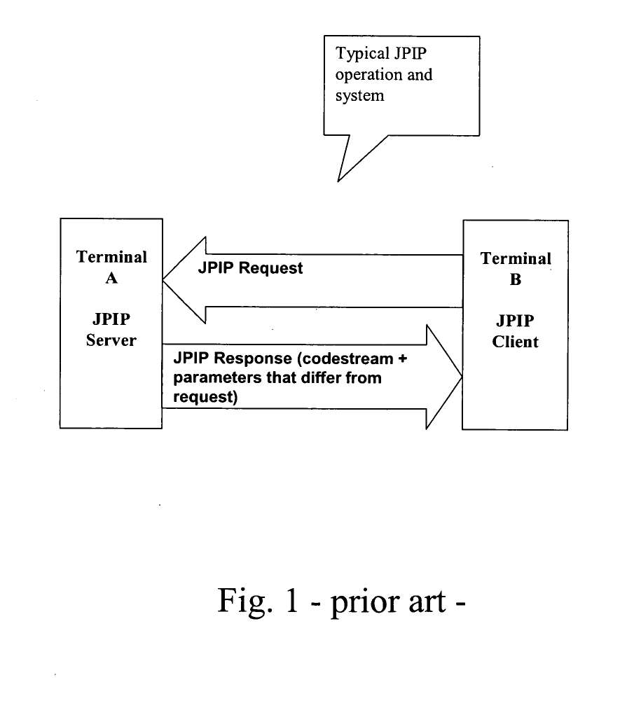

FIG. 1 shows a typical JPIP system, which typically is of a client-initiated server-controlled type mentioned above. As shown in FIG. 1, the JPIP system consists of a JPIP server (named terminal A) and at least one JPIP client (named terminal B). The client and server define end-points of the system. JPIP is a protocol between such two end points A and B, for interactive image sharing. In the illustrated typical scenario, client ‘B’ sends a JPIP request to request for content, e.g. to request for a particular part of a codestream. Server ‘A’ responds with the content/codestream requested together with parameters that reflect in which way or ways the response is different from the request. Basically, this means that the client B needs a response from server A and its own request parameters to decode the codestream and to render the image. For example, the client requests a particular Region of Interest RoI defined by parameters X (x1, x2) and Y (y1, y2). The server is capable to meet parameter X, but not Y and responds with parameter Y′. Then, the client needs to know that although he requested an RoI with parameters X & Y, he needs to know that the server will serve with parameters X & Y′.

In the above example, request parameters define a certain RoI. Nevertheless, in a modification, a request parameter may define the image resolution in case of the content being an image. Thus, generally, the parameters may define any certain quality of service QoS, of which the RoI is an example only.

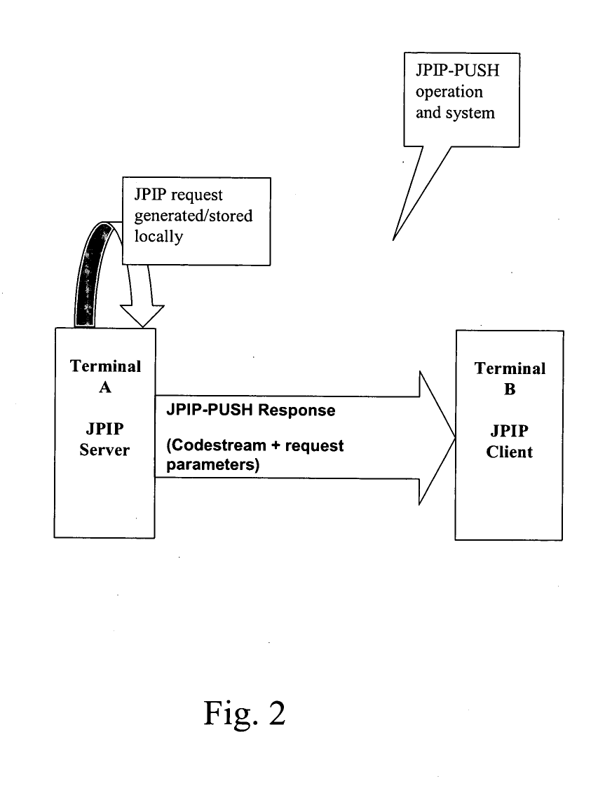

FIG. 2 shows some of the typical actions or steps involved according to the present invention. As shown in FIG. 2, the JPIP system still consists of a JPIP server (named terminal A) and at least one JPIP client (named terminal B). The client and server define end-points of the system. JPIP is an example of the protocol between such two end points A and B, for interactive image sharing.

In case of the proposed concept of JPIP-PUSH, instead of the client, i.e. terminal B sending the JPIP request, the server, i.e. terminal A generates and receives this request locally, and in response to the request pushes the JPIP response (i.e. the JPEG 2000 coded data (i.e. content) together with the server generated compatible JPIP request) to the client, i.e. terminal B.

The JPEG 2000 coded response data together with the server compatible JPIP request enables terminal B as the client to render the image.

Typically, as explained above in relation to FIG. 1, if a JPIP server cannot serve the JPIP request exactly, it puts the modified parameters as part of the JPIP response. In contrast thereto, according to the present invention and the proposed JPIP-PUSH concept, both, the requester and the server, are located on the same side. That is, the request is generated by the server and thus the server modifies the original request (generated by its own) to the closest fitting match to what the server can serve. Hence, basically the JPIP-PUSH response according to the present invention consists of JPEG 2000 response data (content being pushed in the multicast content streaming) and the JPIP request that generated/triggered those content data being pushed. FIG. 2 illustrates this typical JPIP-PUSH implementation scenario.

The proposed JPIP-PUSH concept thus allows an end-user (operating its terminal as a server entity) to share content such as images with a large number of users (the respective terminal of which is operated as a client entity in such case) with bandwidth and/or display constrained environments at a minimal cost. In this regard, the JPIP-PUSH response is multicast to a plurality of (at least one) client entities which previously indicated their “willingness” to receive the content. (JPIP is otherwise a point-to-point protocol that can be made to work in a pseudo point-to-multipoint manner using e.g. a media conferencing unit.)

As outlined above, the JPIP-PUSH system falls in the first category, i.e. Server-initiated server-controlled interactive imaging. This system allows extending an otherwise point-to-point protocol (JPIP) to share image media with large number of users (though at the cost of client-controlled interactivity), while server initiated-server controlled interactivity would still be possible. Insofar, this kind of system is very similar to a typical streaming media scenario. Multicasting is an approach that can be used to share content via JPIP-PUSH with a large number of participants.

One way to transport content via JPIP-PUSH such as audio/video media over a multicast network is FLUTE (file delivery over unidirectional transport). FLUTE is an extension of ALC (asynchronous layered coding), which is basically designed for the transport of arbitrary binary objects. FLUTE provides the infrastructure to carry information to enable the application to interpret the received binary object. This is accomplished using the File Descriptor Table FDT and other FLUTE mechanisms. This fits very well with the JPIP-PUSH use case, as the JPIP response can be seen as the binary object being transported. The related and necessary information for “interpreting” the JPIP-PUSH response at the receiving side (i.e. at the client), i.e. the JPIP request and parameters/metadata are in such scenario sent as part of the FDT packet (File Delivery Table, as specified in RFC 3926) and this enables the client to recover the JPEG 2000 coded data sent over FLUTE.

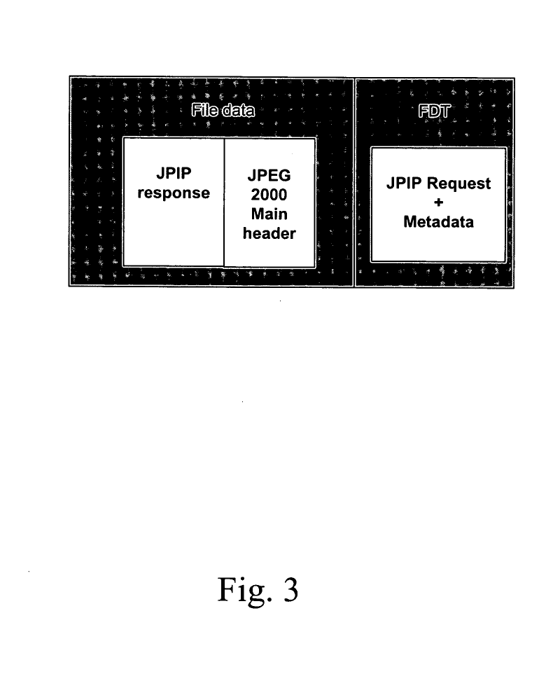

FIG. 3 shows a conceptual constitution of JPIP-Push data transferred over Flute without going into details of bit/byte numbers etc. As shown in FIG. 3, the JPIP request (generated at the server and either in the version modified by the server or in the originally generated version if the server did not modify it) together with metadata such as request parameters or other metadata is part of the a FDT packet i.e. of the file descriptor table FDT in that FDT packet, where the FDT part is the header of the packet and the file date represents the payload of the packet. The file data that this FDT (file descriptor table) instance refers to contains the JPIP response together with the JPEG 2000 main header (for the image in question). These two, FDT and file data, constitute the content codestream delivered to the plurality of (or to at least one) clients in the JPIP-PUSH multicast streaming.

The present invention thus combines the inherent efficiencies in transmission and decoding requirements provided by the JPEG 2000/JPIP protocols and modifies it to enable a simple, scalable and robust method of an image sharing method. Thus, it enables an image-streaming service which in result resembles other media streaming services.

The JPIP-PUSH system can be implemented on any high-end multimedia terminal that has support for any signaling protocol like HTTP, SIP, or the like and for a reliable multicast transport protocol like FLUTE and that is JPIP enabled. The choice of device ranges from a personal computer PC to a networked personal digital assistant PDA to a mobile phone. The node sharing the images (herein referred to as server entity) either has pre-stored JPIP requests (some standard requests like say, Thumbnail request) or has a mechanism (such as a user Interface UI) to generate the JPIP request on the fly on the image being shared. The request used in JPIP-PUSH is released from the server either after generating the request using the user interface or other means or after retrieving it from a memory in which pre-stored requests are maintained. Also, a generated request may be stored by the user for being used again upon retrieving the request. Note that the JPIP request is released from server entity to server entity. But, the request is released from a JPIP-client module (not shown) residing inside the server entity to a JPIP-server module residing inside the Server Entity, where the server entity refers to a logical entity that is doing the multicast content pushing.

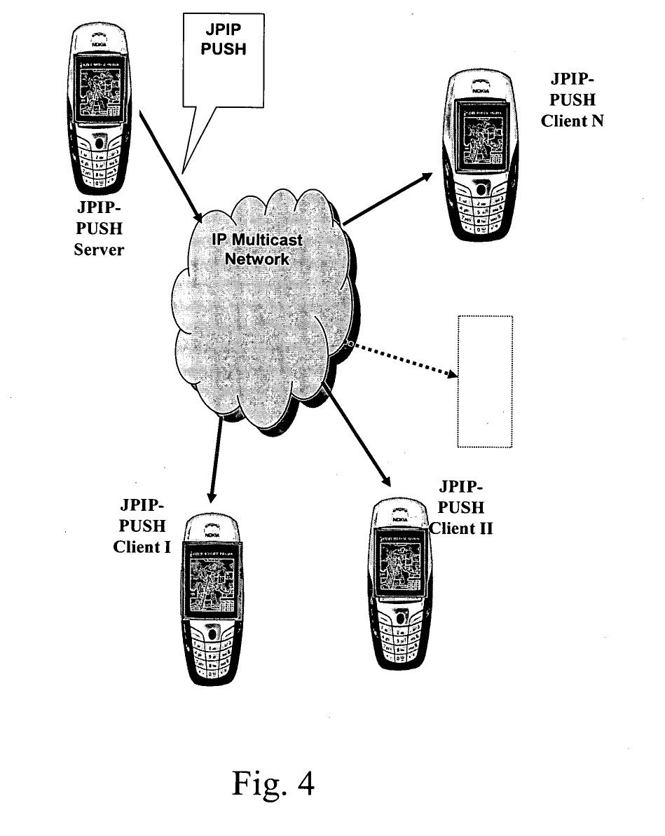

FIG. 4 shows a typical JPIP-PUSH scenario. A server entity is shown which responds to a request (not shown) by sending a JPIP-PUSH request via an IP based multicast network to at least one client entity. FIG. 4 shows client entities I, II and N. Further client entities that might be involved in the multicast content streaming via JPIP-PUSH are indicated only as dotted line(s). As shown, each server and/or client is equipped with a user interface consisting of at least a display and a keyboard to enable man-machine interaction.

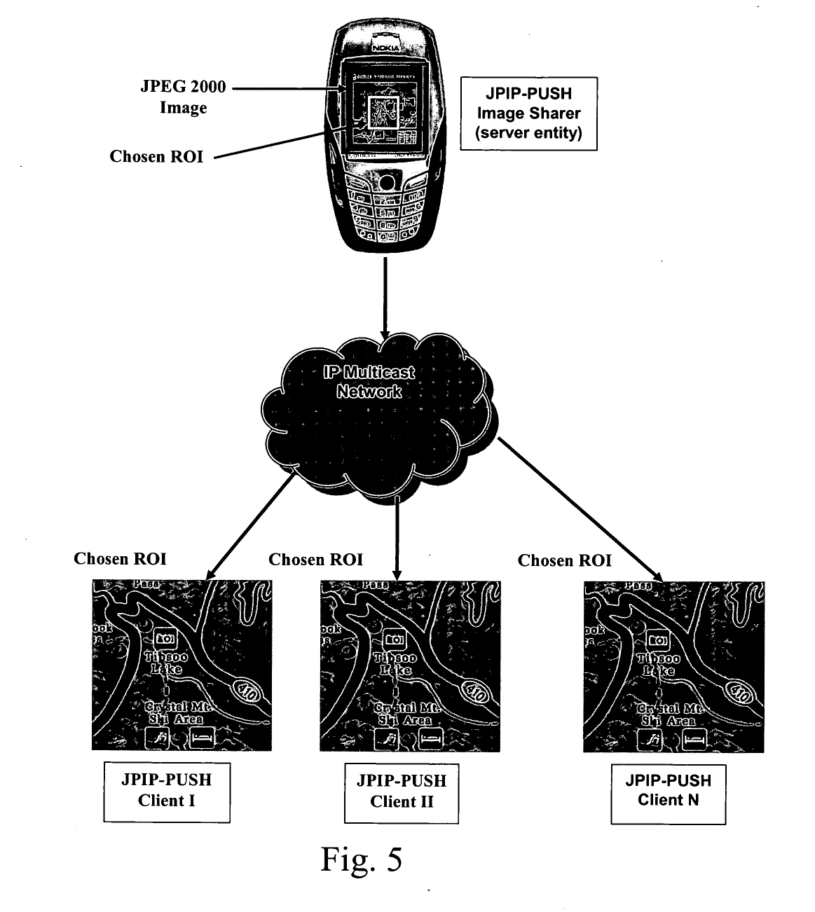

FIG. 5 shows a more specific typical case of a JPIP-PUSH scenario. The server entity named JPIP-PUSH image sharer is displaying a JPEG 2000 image representing content. Within that image, using the user interface, a user has chosen a region of interest—ROI. This part of the JPEG 2000 image is the content actually to be streamed/pushed to the multicast streaming participants. As a result of pushing the selected ROI, the displays of the client entities merely display that part of the JPEG 2000 image at the server entity, which is defined by the ROI. Thus, content can be pushed in a multicasting way in a resource efficient manner since not the entire image is to be sent.

FIGS. 4 and 5 thus illustrate a high level representation of the system according to the present invention which is configured for multicast content pushing between a server entity and at least one client entity. In the illustrated example, the system makes use of an infrastructure provided by an IP based multicast network. However, other networks capable of multicasting can be used.

Since most of sub-blocks used for this system like JPIP, JPEG 2000 decoder, Multicast-transport, etc. can be used in their existing form, only a new application that establishes coordination between these sub-blocks is configured in order to implement the present invention.

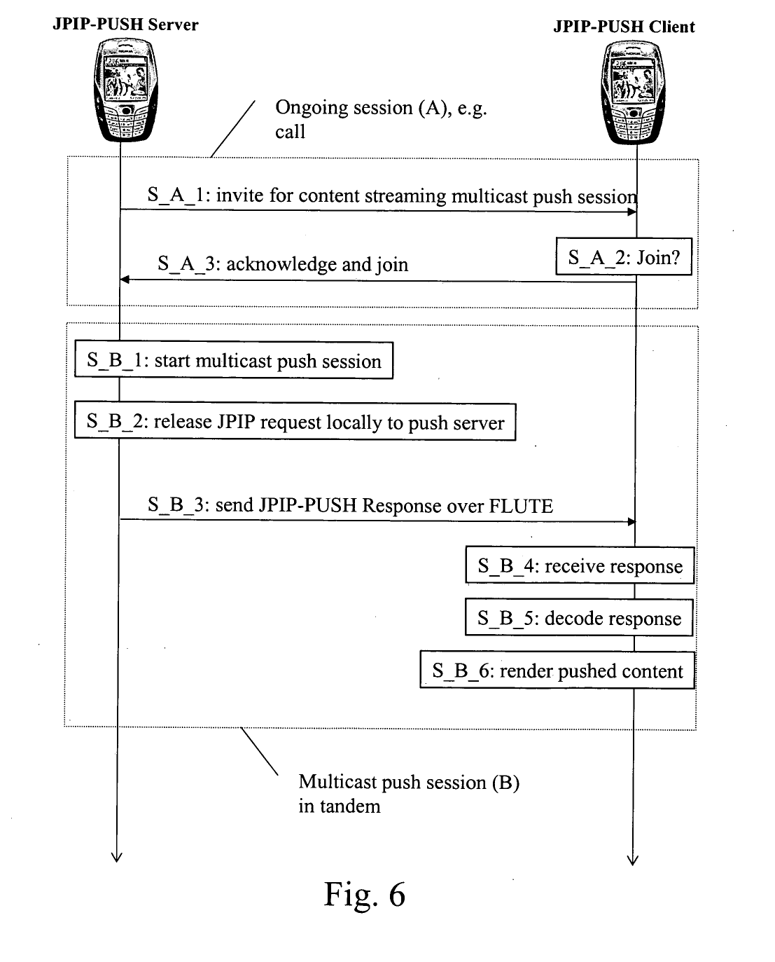

FIG. 6 shows a working implementation according to the present invention on a signaling level. The network and its constituent components are not shown as they are transparent in connection with the present invention.

Basically, the server entity as an image-sharer invites the other nodes to join a multicast-session. The information regarding this can be sent either via some signaling protocol like SIP, HTTP, etc. or even via a Voice-call when a multiparty audio/video conference is already in progress. Thus the participants are made aware of the likely content and “the motive” to join the image streaming session. In a Rich Call scenario, streamed images together with an on-going audio and/or video call can still significantly enrich the call experience.

Once one or more participants join into the multicast session, the server entity as a content sharer (e.g. image-sharer) starts sending the images representing the content over this session. Those images can either be pre-stored and thus loaded from a memory or are generated on the fly by the server entity e.g. using a camera integrated or connected to the server. In case of audio data representing the content the same process is followed, i.e. the audio data can be loaded/retrieved from a memory or generated using e.g. a microphone integrated or connected to the server. Any suitable user-interface can be used to generate the JPIP requests, which will be used to generate the images on the fly. JPIP-PUSH uses locally generated JPIP requests and responses, i.e. released at the server entity by either retrieving them from a memory or generating them. The response is sent over any suitable multicast network protocol like FLUTE.

The participant(s) then recover the content (e.g. images) being streamed over FLUTE used as a transport session for the content and decode it on their end using their JPIP stack and render the image.

SIP that has already been adopted by 3GPP can also be used for JPIP-PUSH. Thus, SIP could be used to establish the FLUTE session in tandem with an on-going multi-point video conferencing session. JPIP-PUSH image streaming can thus be provided along with the other audio, video and image related services over a unified interface. Such an arrangement makes JPIP-PUSH easier to deploy and thus more practicable.

FIG. 6 shows details of the signaling used in such scenario, which is for example as follows.

Note that in order to keep the illustration easy to illustrate, only one client entity is illustrated as being involved in the signaling. It is, however, to be understood that in the multicast content streaming concept as proposed according to the present invention as “JPIP-PUSH”, a plurality of client entities, but at least one client entity is involved. Signaling messages are illustrated as arrows in horizontal direction between entities involved, the vertical sequence of signaling messages represents the sequence in time of the respective signaling messages involved.

Processing blocks/actions (or steps) performed by a respective entity upon receipt of or prior to releasing of a signaling message are also illustrated. Those, steps/blocks are for example realized by software code portions which comprise processor implementable instructions for performing the actions/steps of the method according to at least an example of the present invention within the client-server system. To this end, the system and/or the respective entities thereof comprise a respective computer-readable medium on which the software code portions are stored, which code portions are directly loadable into an internal memory of the client-server computer system, i.e. those code portions performed by a server entity are loaded to an internal memory of the server entity, whereas those code portions performed by at least one client entity are loaded to an internal memory of the respective client entity. The code portions are carried out/rendered effective by respective processors at the entities such as ASICs or DSPs. Notwithstanding this, they can be realized in an alternative implementation as “mere” hardware.

Independent of the realization as hardware/software code portions, the present invention accomplishes the following functionality.

As shown in FIG. 6, the method for multicast content pushing between a server entity and at least one client entity comprises the following actions/steps. In a step S_A_1, the server entity sends an inviting signaling to the at least one client entity to invite the client(s) to join a multicast content streaming session. This step of inviting comprises sending the invitation information to the at least one client entity in a signaling message of an ongoing session. The ongoing session can be a SIP or HTTP session between the server and client entities and is denoted as “A”. Nevertheless, it is also possible that the step of inviting comprises sending the invitation information to at least one client entity within a call of an ongoing session, e.g. a voice call or multi-media call/Rich call, or the like.

In a Step S_A_2, the client entities perform a respective decision on whether to join the invited multicast push session or not. If so, the respective client entity sends in step S_A_3 an answering signaling to the server entity, informing that the client entity joins the invited multicast content streaming session.

Steps S_A_1 to S_A_3 form part of an ongoing session A, e.g. of a call within a session.

The following steps S_B_1 to S_B_6 form part of the multicast content push session “as such” and denoted with “B”. The push session can be active in tandem to the session “A” used for inviting purposes.

For such a multicast content push session, the server entity in step S_B_1 starts the multicast content push session. Following this, it releases, locally at the server entity and to the server entity, a request for multicast content streaming as shown in step S_B_2. The server entity itself responds to that released request in step S_B_3 by sending a response to the request to the at least one client entity that joined the multicast content streaming session. Details of those steps S_B_2 and S_B_3 have been explained further above with reference to FIG. 2.

In particular, the step of releasing may reside in generating a request for multicast content streaming at the server entity via a user-interface. In such case, the user operates the user interface to generate/compose a respective request. Since such a request can be stored at the server entity, or pre-configured requests can be loaded to the server entity (at manufacturing or via a download from a service center later on) the step of releasing can also reside in retrieving a request for multicast content streaming at the server entity from pre-stored requests.

Furthermore, in order to send the response in step S_B_3, the step of responding comprises composing a response including the multicast streaming content and the request including parameters for multicast content streaming. Also this has been discussed above in relation to FIGS. 2 and 3.

As mentioned already, the sending of the response uses a separate multicast content streaming transport session, which is operative in tandem to the ongoing session used for invitation to join the multicast content streaming session. Preferably, such multicast content streaming transport session is a FLUTE session conformant to RFC 3926.

At each of the at least one client entity that joined the multicast content streaming session, there are carried out the step S_B_4 of receiving the response, the response including the multicast streaming content and the request including parameters for multicast content streaming, as well as step S_B_5 of decoding the response, and step S_B_6 of rendering the pushed multicast streaming content at the at least one client entity using the parameters contained in the response.

The rendering may result in displaying pushed content on a display of the client entity and/or in playing it via a loudspeaker of the client entity, dependent on whether content is e.g. image/video or audio or a combination thereof, or executing it in a processor device of the client entity in case the content is executable code.

Although the present invention has been described herein above mainly with regard to the method and signaling involved, it is apparent that the present invention also concerns correspondingly adapted server entities, which in cooperation with at least one client entity constitute an accordingly configured system.

It is to be noted that the client/server entities are illustrated and described with reference to block circuit diagrams only to keep the description comprehensive. Among the blocks of the block circuit diagrams, only those interconnections having a relation to the claimed invention are illustrated. However, this does not exclude other interrelations/interconnections between blocks from existing. However, those interconnections not shown may be considered to be inherent to such arrangement as will be appreciated by those skilled in the art. Although blocks are sometimes illustrated as distinct blocks, the actual realization could be in a single block, since the block circuit diagram is conceived to illustrate and explain the functional interrelations between blocks of a client/server entity and between a client entity and a server entity. Moreover, the block circuit diagrams represent the devices in terms of e.g. the layered protocol stacks underlying their operational behavior. Hence, distinct blocks could be jointly realized using e.g. only one DSP device or ASIC. It is emphasized again that a terminal and/or a user agent UA of such terminal may combine a server entity functionality as well as a client entity functionality. However, in order to keep the drawing and explanation simple, such aspects are described and illustrated separately.

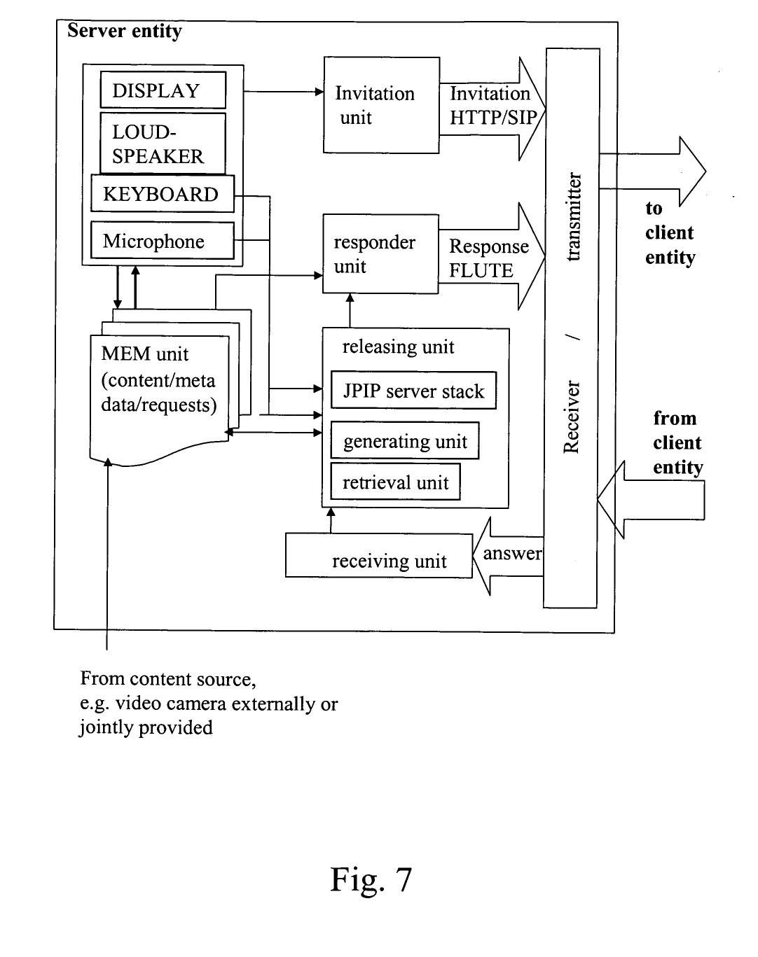

FIG. 7 shows, as a block circuit diagram, those components/units of a server entity being related to a server entity aspect the present invention.

The server entity comprises a man-machine-interface MMI, comprising for example a display, a loudspeaker, a keyboard and a microphone. However, additional or alternative input and/or output devices/units can be provided (such as e.g. a (video/still picture) camera, a mouse, a pen, etc.), including the omission of one of those shown. Illustrated in FIG. 7 is the possibility to supply content from a (optionally external) content source (not shown) such as a video camera externally or jointly provided to the server entity (user terminal).

The MMI as well as the content source are connectable and/or connected to a memory unit MEM. The memory unit MEM can be a single memory unit having individual partitions or can be configured to consist of plural individual memory elements. Partitions or elements of the memory unit store therein content data, metadata, requests, inputs received via the MMI, and/or internal processing results obtained in the course of the present invention being carried out.

Content data are supplied from e.g. an external device (not shown) such as a camera, which may also form part of the MMI as explained above, or from an external data source such as a server. This is indicated by the arrow labeled “from content source”. Metadata as well as requests can likewise be supplied from an external device, or can be input from the MMI 1 as indicated by the vertical (downward) arrow. Any data in the memory unit partitions/elements can be output to the MMI, as illustrated by the vertical upward arrow. Outputting to the MMI may serve for displaying or playing (using loudspeaker) the data or even for editing data (e.g. request data) using the keyboard or other means such as pen/mouse.

Note that the memory unit MEM is configured to store content, wherein content consists of at least one of audio data, video data, image data, text data, executable code data and metadata descriptive of attributes of the audio, video, image, text data and/or even executable code data, and also re-defined requests (e.g. “thumbnail” requests).

The MMI is connected to an invitation unit configured to invite at least one client entity to join a multicast content streaming session. The invitation can be composed using the MMI, e.g. using the keyboard or other input unit, to compose a signaling message. The invitation unit is configured to send the invitation information to the at least one client entity in such a signaling message of an ongoing session. Also, the invitation unit is configured to send the invitation information to the at least one client entity within a call of an ongoing session. In such a case, the invitation can be composed using the microphone as a part of the MMI. The invitation is sent using a transceiver unit (transmitter/receiver unit (ormeans)) to a plurality of client entities to be invited to the multicast content streaming session.

Via the transceiver unit an answer is received from the client entities at a receiving unit. The receiving unit is configured to receive an answer from the client entity, whether the client entity joins the invited multicast content streaming session.

A releasing unit of the server entity is configured to release to the server entity a request for multicast content streaming, responsive to the receipt of such an answer. The releasing unit comprises a generating unit configured to generate a request for multicast content streaming at the server entity via a user-interface. To this end, the generating unit interfaces with the MMI, in particular input devices thereof such as keyboard or microphone as shown, but also (not shown) it may interface a display/pen combination in case the input is provided by a pen in combination with a sensitive display screen. Also, the releasing unit comprises a retrieval unit configured to retrieve a request for multicast content streaming at the server entity from a memory unit containing pre-stored requests. To this end, the releasing unit/retrieval unit interfaces with the memory unit MEM for retrieving a corresponding request as specified by e.g. a keyboard input received from the MMI at the retrieval unit. The releasing unit operates using a JPIP server protocol stack.

A responder unit connected to the releasing unit is configured to respond to the released request by sending a response to the request to the at least one client entity that joined the multicast content streaming session. The response as such is forwarded from the responder unit via the transceiver unit to the client entities that joined the multicast content streaming session. In this regard, as explained beforehand, the responder unit is configured to compose a response including the multicast streaming content and the request including parameters for multicast content streaming. Thus, the responder unit may also access the memory unit as shown in FIG. 7. The responder unit is configured to send the response using a separate multicast content streaming transport session, which is operative in tandem to the session used for invitation to join the multicast content streaming session. The multicast content streaming transport session of the response is for example a FLUTE session conformant to RFC 3926.

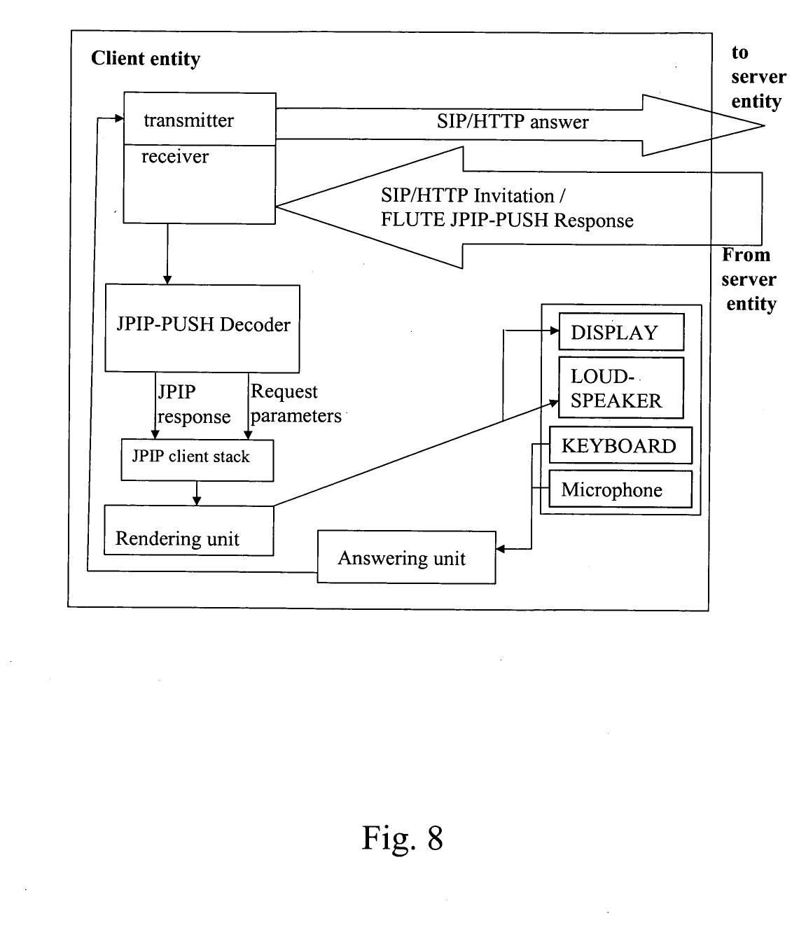

FIG. 8 shows, as a block circuit, diagram those components of a client entity.

Similarly to the server entity, the client entity comprises a man-machine-interface MMI, comprising for example a display, a loudspeaker, a keyboard, and a microphone. However, additional (such as a (video/still image) camera) or alternative input and/or output devices can be provided (e.g. a mouse, pen, etc.), including the omission of one of those shown. The MMI is connectable and/or connected to a memory unit (not shown). Under a client entity aspect, the memory unit mainly serves as a working memory, e.g. for intermediate storage of content for display purposes, for intermediate storage of processing results, or the like.

From a server entity, the client entity receives an invitation at a receiver unit thereof. Such invitation is passed on internally (e.g. via a decoder unit/JPIP client stack/rendering unit) to the MMI for perception by the user of the client entity. The user may then decide whether to join the invited multicast content streaming session or not. The user may use the keyboard or microphone to generate an answer using an answering unit, which answer is passed via a transmitter unit of the client entity to the server entity.

In case the client answered to the extent to join the multicast content streaming session, the client receives a response from the server entity at a receiver unit configured to receive such response including the multicast streaming content and the request including parameters for multicast content streaming. E.g. such response is received as a FLUTE JPIP-PUSH response.

The response is passed onwards internally from the receiver unit to a decoder unit configured to decode the response, and further—via the JPIP client protocol stack—to a rendering unit configured to render the multicast streaming content at the at least one client entity using the parameters contained in the response. Based on the result of rendering, output devices of the MMI such as the display and/or loudspeaker are driven so that the user of the client entity may visually/acoustically perceive the pushed content.

As to the expressions JPIP server stack and JPIP client stack as used herein before, it is to be noted that:

JPIP client stack is a part of the JPIP protocol configured and used to generate JPIP requests and to parse JPIP responses and to decode the content such as an image, whereas similarly

JPIP server stack is a part of the JPIP protocol configured and used to parse JPIP requests and to generate JPIP responses.

In the arrangement as illustrated in FIG. 7, the JPIP server stack generates JPIP responses and passes them on to the responder means module, while in the arrangement illustrated in FIG. 8, the JPIP client stack parses the JPIP response received from the JPIP push decoder and passes the JPIP data to the rendering means.

Thus, the present invention has been described in detail above under a method aspect as well as a system aspect involving a server entity aspect as well as a client entity aspect. It is well understood that a corresponding system comprising a server entity and a client entity in interaction with each other according to the present invention can be established and is covered by the idea underlying the present invention. Also, a terminal and/or communication device may be configured to combine a server as well as a client functionality and may act as a server in one instance and act as a client in another instance.

As has been described herein above, the present invention discloses a method for multicast content pushing between a server entity and at least one client entity as well as a corresponding system and client and server entities. The method comprises inviting, by the server entity, at least one client entity to join a multicast content streaming session, answering, by the at least one client entity to the server entity, whether the client entity joins the invited multicast content streaming session, releasing, at the server entity and to the server entity, a request for multicast content streaming, responding, by the server entity, to the released request by sending a response to the request to the at least one client entity that joined the multicast content streaming session.

1. A method for multicast content pushing between a server entity and at least one client entity, the method comprising:
inviting, by the server entity, at least one client entity to join a multicast content streaming session;
answering, by the at least one client entity to the server entity, whether the at least one client entity joins the invited multicast content streaming session;
releasing, at the server entity and to the server entity, a request for multicast content streaming; and
responding, by the server entity, to the released request by sending a response to the request to the at least one client entity that joined the multicast content streaming session.

2. A method according to claim 1, wherein said inviting further comprises
sending invitation information to the at least one client entity in a signaling message of an ongoing session.

3. A method according to claim 1, wherein said inviting further comprises
sending invitation information to the at least one client entity within a call of an ongoing session.

4. A method according to claim 1, wherein said releasing further comprises
generating a request for multicast content streaming at the server entity via a user-interface.

5. A method according to claim 1, wherein said releasing further comprises
retrieving a request for multicast content streaming at the server entity from pre-stored requests.

6. The method according to claim 4, wherein the request is a JPIP request and the multicast streaming content is JPEG 2000 data.

7. The method according to claim 5, wherein the request is a JPIP request and the multicast streaming content is JPEG 2000 data.

8. A method according to claim 1, wherein said responding further comprises
composing a response including
the multicast streaming content and
the request including parameters for multicast content streaming.

9. A method according to claim 1, wherein said responding further comprises
sending the response using a separate multicast content streaming transport session, which is operative in tandem to an ongoing session used for invitation to join the multicast content streaming session.

10. A method according to claim 9, wherein
the multicast content streaming transport session is a FLUTE session.

11. A method according to claim 1, further comprising:
receiving the response at the at least one client entity that joined the multicast content streaming session, the response including the multicast streaming content and the request including parameters for multicast content streaming;
decoding the response; and
rendering the multicast streaming content at the at least one client entity using the parameters contained in the response.

12. A system,
the system being configured for multicast content pushing between a server entity and at least one client entity and comprising
invitation unit, at the server entity, configured to invite the at least one client entity to join a multicast content streaming session;
answering unit, at the at least one client entity, configured to answer to the server entity, whether the at least one client entity joins the invited multicast content streaming session;
releasing unit, at the server entity, configured to release to the server entity a request for multicast content streaming; and
responder unit, at the server entity, configured to respond to the released request by sending a response to the request to the at least one client entity that joined the multicast content streaming session.

13. A system according to claim 12, wherein
the invitation unit is configured to send invitation information to the at least one client entity in a signaling message of an ongoing session.

14. A system according to claim 12, wherein
the invitation unit is configured to send invitation information to the at least one client entity within a call of an ongoing session.

15. A system according to claim 12, wherein the releasing unit comprises
generating unit configured to generate a request for multicast content streaming at the server entity via a user-interface.

16. A system according to claim 12, wherein
the releasing unit comprises a retrieval unit configured to retrieve a request for multicast content streaming at the server entity from a memory containing pre-stored requests.

17. A system according to claim 15, wherein the request is a JPIP request.

18. A system according to claim 16, wherein the request is a JPIP request.

19. A system according to claim 12, wherein the responder unit is configured to
compose a response including
multicast streaming content and
the request including parameters for multicast content streaming.

20. A system according to claim 12, wherein the responder unit is configured to
send the response using a separate multicast content streaming transport session, which is operative in tandem to a session used for invitation to join the multicast content streaming session.

21. A system according to claim 20, wherein
the multicast content streaming transport session is a FLUTE session.

22. A client entity,
configured to receive multicast content pushed from a server entity,
the client entity comprising:
a receiver configured to receive a response including multicast streaming content and the request including parameters for content streaming;
a decoder configured to decode the response; and
a rendering unit configured to render the multicast streaming content at the at least one client entity using parameters contained in the response.

23. The client entity according to claim 22, wherein the request is a JPIP request and the multicast streaming content is JPEG 2000 data.

24. A server entity,
configured to multicast content pushing to at least one client entity,
the server entity comprising:
invitation unit configured to invite at least one client entity to join a multicast content streaming session;
receiving unit configured to receive an answer from the at least one client entity, whether the at least one client entity joins the invited multicast content streaming session;
releasing unit configured to release to the server entity a request for multicast content streaming; and
responder unit configured to respond to the released request by sending a response to the request to the at least one client entity that joined the multicast content streaming session.

25. A server entity according to claim 24, wherein the invitation unit is configured to send invitation information to the at least one client entity in a signaling message of an ongoing session.

26. A server entity according to claim 24, wherein the invitation unit is configured to send invitation information to the at least one client entity within a call of an ongoing session.

27. A server entity according to claim 24, wherein the releasing unit comprises generating unit configured to generate a request for multicast content streaming at the server entity via a user-interface.

28. A server entity according to claim 24, wherein the releasing unit comprises retrieval unit configured to retrieve a request for multicast content streaming at the server entity from a memory containing pre-stored requests.

29. A server entity according to claim 27, wherein the request is a JPIP request and content being streamed is JPEG 2000 data.

30. A server entity according to claim 28, wherein the request is a JPIP request and content being streamed is JPEG 2000 data.

31. A server entity according to claim 24, wherein the responder unit is configured to
compose a response including
multicast streaming content and
the request including parameters for multicast content streaming.

32. A server entity according to claim 24, wherein the responder unit is configured to
send the response using a separate multicast content streaming transport session, which is operative in tandem to a session used for invitation to join the multicast content streaming session.

33. A server entity according to claim 32, wherein
the multicast content streaming transport session is a FLUTE session.

34. A computer program product,
configured for a client-server computer system and comprising processor implementable instructions stored as software code portions on a computer-readable medium loadable into an internal memory of the client-server computer, configured for providing for multicast content pushing between a server entity and at least one client entity, comprising:
inviting, by the server entity, at least one client entity to join a multicast content streaming session;
answering, by the at least one client entity to the server entity, whether the at least one client entity joins the invited multicast content streaming session;
releasing, at the server entity and to the server entity, a request for multicast content streaming; and
responding, by the server entity, to the released request by sending a response to the request to the at least one client entity that joined the multicast content streaming session.

35. The computer program product according to claim 34, wherein said releasing further comprises
generating a request for multicast content streaming at the server entity via a user-interface.

36. The computer program product according to claim 34, wherein said releasing further comprises
retrieving a request for multicast content streaming at the server entity from pre-stored requests.

37. A server entity,
configured to multicast content pushing to at least one client entity,
the server entity comprising:
means for inviting at least one client entity to join a multicast content streaming session;
means for receive an answer from the at least one client entity, whether the at least one client entity joins the invited multicast content streaming session;
means for releasing to the server entity a request for multicast content streaming; and
means for responding to the released request by sending a response to the request to the at least one client entity that joined the multicast content streaming session.

38. A client entity,
configured to receive multicast content pushed from a server entity,
the client entity comprising:
means for receiving a response including multicast streaming content and the request including parameters for content streaming;
means for decoding the response; and
means for rendering the multicast streaming content at the at least one client entity using parameters contained in the response.
